(19) United States
(12) Patent Application Publication
(10) Pub. No.: US 2023/0348696 A1
(43) Pub. Date: Nov. 2, 2023

(54) COMPOSITION, METHOD FOR THE MANUFACTURE THEREOF, AND ARTICLES PREPARED THEREFROM

(71) Applicant: SHPP GLOBAL TECHNOLOGIES B.V., Bergen op Zoon (NL)

(72) Inventors: Hariharan RAMALINGAM, Bangalore (IN); Zheng WANG, Shanghai (CN); Gabrie HOOGLAND, Bergen op Zoom (NL)

(21) Appl. No.: 18/038,559

(22) PCT Filed: Nov. 23, 2021
(86) PCT No.: PCT/IB2021/060884

§ 371 Date: May 24, 2023

(30) Foreign Application Priority Data
Dec. 2, 2020 (EP) 20211292.6

(51) Int. Cl. C08K 7/10; C08K 3/22; C08J 3/21

(52) U.S. Cl. CPC C08K 7/10; C08K 3/22; C08J 3/212; C08K 2003/2227; C08K 2201/003; C08K 2201/004; C08K 2201/006; C08K 2201/005; C08J 2345/00; C08J 2379/08; C08J 2381/06; C08J 2323/08

(57) ABSTRACT

A composition including particular amounts of a polyetherimide, a poly(arylene ether sulfone), or a cyclic olefin copolymer and a filler is described herein. Samples of the composition can exhibit an advantageous combination of properties, and the composition can be used in various articles. Methods of making the composition are also described.

### CROSS-REFERENCE TO RELATED APPLICATION

This application claims priority to and the benefit of European Patent Application No. 20211292.6, filed on Dec. 2, 2020, the contents of which are incorporated by reference herein in its entirety.

### BACKGROUND

Thermoplastic polymers, including polyetherimides and polysulfones, are useful in the manufacture of articles and components for a wide range of applications, from automotive parts to electronic appliances. Because of beneficial properties such as transparency and impact resistance, polyetherimides and polysulfones have also been used in optical applications including as sensor lenses, optical interconnectors, transceivers, light guides, camera lenses, eyeglass and safety glass lenses, illumination lenses such as light fixtures, flashlight and lantern lenses, and motor vehicle headlight lenses and covers. Since many optical articles are used in a high-temperature environment or have to be processed under harsh conditions, it is desirable for the materials to have the ability to withstand elevated temperatures without deformation or discoloration, and the ability to maintain good optical properties even when processed using conventional molding processes. To date, many optical lenses are made from glass as polymer materials were not able to provide the necessary dimensional stability, particularly for use in single mode fiber optic connectors.

Therefore, there is a continuing need in the art for an improved composition that is particularly well suited for optical applications. It would be particularly advantageous to provide a composition having a low coefficient of thermal expansion and high infrared transmission.

### SUMMARY

A composition comprises greater than 50 weight percent to less than 75 weight percent of a polyetherimide, a poly(arylene ether sulfone), or a cyclic olefin copolymer; and greater than 25 weight percent to less than 50 weight percent of a filler; wherein when the polymer comprises the polyetherimide, the filler comprises wollastonite fibers having an average fiber diameter of 5 micrometers to 10 micrometers and an average fiber length of 55 micrometers to 75 micrometers, a surface area of 2.5 m²/g to less than 2.9 m²/g, a bulk density of 0.42 g/cc to 0.50 g/cc, and a silica content of 52% to 55%; or boehmite having an average particle size (D50), as determined by laser light scattering, of 0.4 micrometer to less than 0.9 micrometer; when the polymer comprises the poly(arylene ether sulfone), the filler comprises wollastonite fibers having an average fiber diameter of 1 micrometers to 5 micrometers and an average fiber length of 5 micrometers to 12 micrometers, a surface area of 3.8 m²/g to 4.3 m²/g, and a bulk density of 0.48 g/cc to 0.56 g/cc; or boehmite having an average particle size (D50), as determined by laser light scattering, of 0.4 micrometer to less than 0.9 micrometer; and when the polymer comprises the cyclic olefin copolymer, the filler comprises wollastonite fibers having an average fiber diameter of 10 micrometers to 15 micrometers and an average fiber length of 140 micrometers to 165 micrometers, a surface area of 1.0 m²/g to 1.8 m²/g, and a bulk density of 0.18 g/cc to 0.26 g/cc; wherein weight percent is based on the total weight of the composition.

A method of making the composition comprises: blending the polyetherimide, the poly(arylene ether sulfone), or the cyclic olefin copolymer and the filler.

A method of making the composition, wherein the composition comprises the polyetherimide, comprises: contacting an aromatic bis(ether anhydride) and an organic amine to provide a polyetherimide precursor; combining the filler with the polyetherimide precursor to provide a mixture; and heating the mixture under conditions effective to provide the corresponding polyetherimide.

An article comprises the composition.

The above described and other features are exemplified by the following figures and detailed description.

### BRIEF DESCRIPTION OF THE DRAWINGS

The following figures are exemplary embodiments wherein the like elements are numbered alike.

FIG. 1 is a scanning electron microscopy (SEM) image of the composition according to example 8.

FIG. 2 is a scanning electron microscopy (SEM) image of the composition according to example 61.

FIG. 3 is a scanning electron microscopy (SEM) image of the composition according to example 65.

### DETAILED DESCRIPTION

The present inventors have unexpectedly discovered that compositions including a polyetherimide, a poly(arylene ether sulfone), a cyclic olefin copolymer, or a combination thereof and particular inorganic fillers can provide a desirable combination of properties. In particular, the compositions described herein can form thin films from a solution-based method exhibiting low coefficients of thermal expansion (CTE), high infrared (IR) transmission, and good processability. The compositions described herein can be particularly well suited for a variety of articles, specifically articles for optical applications.

Accordingly, a composition is an aspect of the present disclosure. The composition comprises a polyetherimide, a poly(arylene ether sulfone), a cyclic olefin copolymer, or a combination thereof.

In an aspect, the composition comprises the polyetherimide. Polyetherimides comprise more than 1, for example 2 to 1000, or 5 to 500, or 10 to 100 structural units of formula (1)

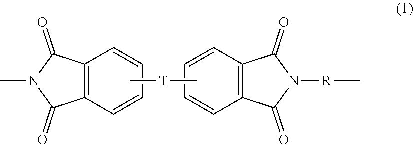

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In an aspect R is divalent group of one or more of the following formulas (2)

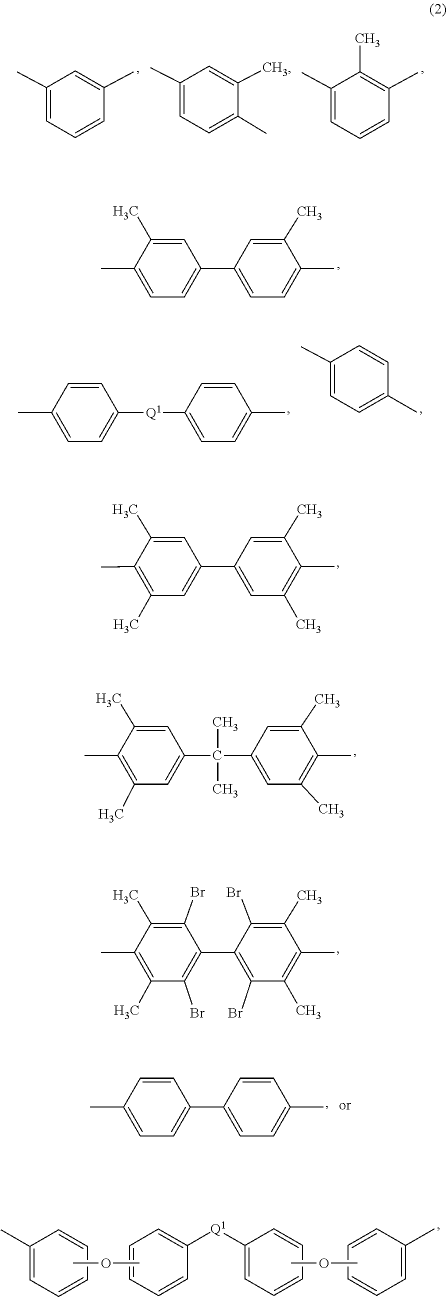

wherein Q¹ is —O—, —S—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In an aspect R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In an aspect, at least 10 mole percent or at least 50 mole percent of the R groups contain sulfone groups, and in other aspects no R groups contain sulfone groups.

Further in formula (1), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (3)

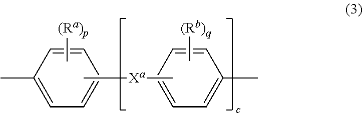

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

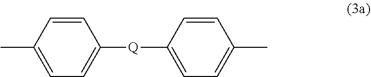

wherein Q is —O—, —S—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In an aspect Z is derived from bisphenol A, such that Q in formula (3a) is 2,2-isopropylidene.

In an aspect in formula (1), R is m-phenylene, p-phenylene, or a combination comprising at least one of the foregoing, and T is —O—Z—O— wherein Z is a divalent group of formula (3a). Alternatively, R is m-phenylene, p-phenylene, or a combination comprising at least one of the foregoing, and T is —O—Z—O— wherein Z is a divalent group of formula (3a) and Q is 2,2-isopropylidene. Such materials are available under the trade name ULTEM from SABIC. Alternatively, the polyetherimide can be a copolymer comprising additional structural polyetherimide units of formula (1) wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety, an example of which is commercially available under the trade name EXTEM from SABIC.

In an aspect, the polyetherimide is a copolymer that optionally comprises additional structural imide units that are not polyetherimide units, for example imide units of formula (4)

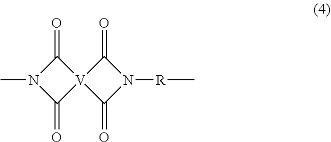

wherein R is as described in formula (1) and each V is the same or different, and is a substituted or unsubstituted C₆₋₂₀ aromatic hydrocarbon group, for example a tetravalent linker of the formulas

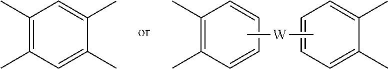

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 mol % to 10 mol % of the total number of units, or 0 mol % to 5 mol % of the total number of units, or 0 mol % to 2 mol % of the total number of units. In an aspect, no additional imide units are present in the polyetherimide.

The polyetherimide can be prepared by any of the methods known to those skilled in the art, including the reaction of an aromatic bis(ether anhydride) of formula (5) or a chemical equivalent thereof, with an organic diamine of formula (6)

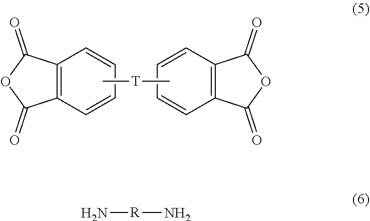

wherein T and R are defined as described above. Copolymers of the polyetherimides can be manufactured using a combination of an aromatic bis(ether anhydride) of formula (5) and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of organic diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1,3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁₋₄ alkylated or poly(C₁₋₄)alkylated derivatives of any of the foregoing can be used, for example a polymethylated 1,6-hexanediamine. Combinations of these compounds can also be used. In an aspect the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing. In an aspect, the organic diamine is m-phenylenediamine, p-phenylenediamine, or a combination thereof, preferably m-phenylene.

The polyetherimide can have a melt index of 0.1 grams per minute (g/min) to 10 g/min, as measured by American Society for Testing Materials (ASTM) D1238 at 340° C. to 370° C., using a 6.7 kilogram (kg) weight. In an aspect, the polyetherimide has a weight average molecular weight (Mw) of 1,000 to 150,000 grams/mole (g/mol or Dalton (Da)), as measured by gel permeation chromatography, using polystyrene standards. In an aspect the polyetherimide has an Mw of 10,000 to 80,000 g/mol. Such polyetherimides typically have an intrinsic viscosity greater than 0.2 deciliters per gram (dl/g), or, more specifically, 0.35 dl/g to 0.7 dl/g as measured in m-cresol at 25° C.

In an aspect, the composition comprises the poly(arylene ether sulfone). As used herein, the term “poly(arylene ether sulfone)” can refer to polymers having repeat units of formula (7)

—Ar¹—SO₂—Ar²—O— (7)

wherein each Ar¹ and Ar² is the same or different, and is a group of formula (8)

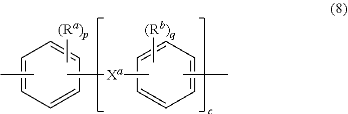

wherein c is 0 or 1, R^{a} and R^{b} are each independently a linear or branched C₁₋₁₀ alkyl, linear or branched C₂₋₁₀ alkenyl, linear or branched C₂₋₁₀ alkynyl, C₆₋₁₈ aryl, C₇₋₂₀ alkylaryl, C₇₋₂₀ arylalkyl, C₅₋₁₀ cycloalkyl, C₅₋₂₀ cycloalkenyl, linear or branched C1-10 alkylcarbonyl, C₆₋₁₈ arylcarbonyl, halogen, nitro, cyano, a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (8), X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. In an aspect, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In an aspect, c is 0 or 1, p and q is each 0, and X^{a} is isopropylidene.

Specific poly(arylene ether sulfone)s that can be used include polyethersulfone (also known as “PES” or “PESU”), which contains at least 85 weight percent of units of formula (8a)

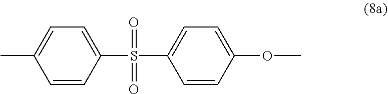

or polyphenylene sulfone (also known as “PPSU” or polyphenylsulfone), which contains at least 85 weight percent of units of formula (8b)

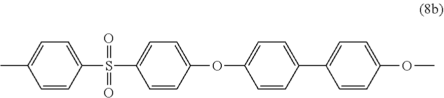

or polyetherethersulfone, which contains at least 85 weight percent of units of formula (8c)

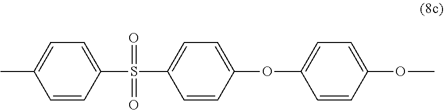

or polysulfone (often referred to as “PSU”), which contains at least 85 weight percent of units of formula (8d)

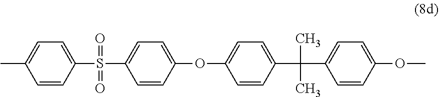

or a combination comprising at least one of the foregoing poly(arylene ether sulfone)s. Copolymers comprising a combination of at least two types of units of formulas (8a), (8b), (8c), and (8d) can also be used.

The poly(arylene ether sulfone)s can be linear or branched, having 1 or more, 2 or more, or 5 or more branching points per 1,000 carbon atoms along the polymer chain. In an aspect, the poly(arylene ether sulfone)s are linear, having 10 or fewer, 5 or fewer, 2 or fewer, or 1 or fewer branching points per 1,000 carbon atoms along the polymer chain. In an aspect, the poly(arylene ether sulfone)s have a glass transition temperature (Tg) of greater than 175° C., specifically of greater than 175° C. to 300° C., or from 200° C. to 280° C., or from 255° C. to 275° C. The poly(arylene ether sulfone)s can further have a weight average molecular weight (Mw) of 500 g/mol to 100,000 g/mol, specifically 1,000 g/mol to 75,000 g/mol, more specifically 1,500 g/mol to 50,000 g/mol, and still more specifically 2,000 g/mol to 25,000 g/mol.

Exemplary poly(arylene ether sulfone)s that can be used include those that are available from sources such as Solvay Specialty Polymers, Quadrant EPP, Centroplast Centro, Duneon, GEHR Plastics, Westlake Plastics, Gharda Chemicals, Sumitomo Chemial, and UJU New Materials Co., Ltd. Commercial grades of poly(phenylsulfone)s include those with the trade names RADEL™, UDEL™, ULTRASON™, GAFONE™, and PARYLS™. Poly(arylene ether sulfone)s are commercially available from Solvay Advanced Polymers K.K. under the trademark of VERADEL™, from BASF Corporation under the trademark of ULTRASON™, and from Sumitomo Chemical Co., Ltd. under the trademark of SUMIKAEXCEL™.

Polyphenylene sulfones are commercially available, including the polycondensation product of biphenol with dichloro diphenyl sulfone. Methods for the preparation of polyphenylene sulfones are widely known and several suitable processes have been well described in the art. Two methods, the carbonate method and the alkali metal hydroxide method, are known to the skilled artisan. In the alkali metal hydroxide method, a double alkali metal salt of a dihydric phenol is contacted with a dihalobenzenoid compound in the presence of a dipolar, aprotic solvent under substantially anhydrous conditions. The carbonate method, in which a dihydric phenol and a dihalobenzenoid compound are heated, for example, with sodium carbonate or bicarbonate and a second alkali metal carbonate or bicarbonate is also disclosed in the art, for example in U.S. Pat. No. 4,176,222. Alternatively, the polyphenylene sulfone can be prepared by any of the variety of methods known in the art.

The molecular weight of the polyphenylene sulfone, as indicated by reduced viscosity data in an appropriate solvent such as methylene chloride, chloroform, N-methylpyrrolidone, or the like, can be greater than or equal to 0.3 dl/g, or, more specifically, greater than or equal to 0.4 dl/g and, typically, will not exceed 1.5 dl/g.

The polyphenylene sulfone weight average molecular weight (Mw) can be 10,000 g/mol to 100,000 g/mol as determined by gel permeation chromatography using ASTM D5296 with polystyrene standards. In an aspect the polyphenylene sulfone weight average molecular weight can be 10,000 g/mol to 80,000 g/mol. Polyphenylene sulfones can have glass transition temperatures (Tg) of 180° C. to 250° C., as determined using differential scanning calorimetry (DSC).

In an aspect, the composition comprises the cyclic olefin copolymer. Cyclic olefin copolymers are derived from copolymerization of a cyclic olefin. Examples of suitable cyclic olefin monomers are norbornene, tetracyclododecene, bicyclo[2,2,1]hept-2-ene, 1-methylbicyclo[2,2,1]hept-2-ene, hexacyclo[6,6,1,1³,6,1¹⁰,13,0²,7,0⁹,14 ]-4-heptadecene, and the like, and combinations thereof. Many such monomers are well known and are described, for example, in U.S. Pat. No. 5,008,356. In the case of cyclic olefin copolymers (COCs), the comonomer or comonomers are chosen from a variety of suitable olefins, including, for example, acyclic olefins. Many such comonomers are also well known in the literature, including, for example, the above-noted U.S. Pat. No. 5,008,356. In an aspect, the cyclic olefin monomer comprises norbornene, and the comonomer comprises acyclic olefins, for example, ethylene, propylene and the like.

In an aspect, the polyetherimide, poly(arylene ether sulfone), cyclic olefin copoylmer or combination thereof can have a transmission of greater than 70% from 850 nm to 1100 nm and from 1200 nm to 1330 nm, determined using UV/Vis spectroscopy of a film, for example having a thickness of 100 micrometers.

The polyetherimide, poly(arylene ether sulfone), cyclic olefin copolymer, or combination thereof can be present in the composition in an amount of greater than 50 weight percent to less than 75 weight percent, based on the total weight of the composition. Within this range, the polyetherimide, poly(arylene ether sulfone), cyclic olefin copolymer, or combination thereof can be present in an amount of 53 to 72 weight percent, or 53 to 70 weight percent, or 53 to 68 weight percent, or 55 to 65 weight percent, or 58 to 62 weight percent.

In addition to the polyetherimide, poly(arylene ether sulfone), cyclic olefin copoylmer or combination thereof, the composition further comprises a filler. The filler can preferably have a refractive index of 1.60 to 1.68, or 1.60 to 1.67, or 1.60 to 1.66 as determined at a wavelength of 587 nanometers. The filler comprises boehmite, wollastonite, or a combination thereof, and each can optionally be surface modified. In an aspect, the filler does not include any surface modifications. As is further described in the working examples below, selection of the filler can depend on the polymer present in the composition (e.g., the polyetherimide, poly(arylene ether sulfone), or cyclic olefin copolymer). Depending on the polymer present in the composition, the filler can further be selected based on one or more of average particle size, surface area, bulk density, or composition. Average particle sizes can be determined by various methods that are generally known including laser light scattering techniques or microscopy, such as scanning electron microscopy. Surface area can refer to the Brunauer-Emmett-Teller (BET) specific surface area, determined according to ISO 9277. Bulk density can refer to the loose bulk density of the filler and can be determined by methods which are generally known, for example according to ASTM D7481-18.

In an aspect, the filler can comprise wollastonite fibers. In an aspect, the wollastonite fibers can have an average fiber diameter of 5 micrometers to 10 micrometers and an average fiber length of 55 micrometers to 75 micrometers. In an aspect, the wollastonite fibers can have an average fiber diameter of 1 to 5 micrometers and an average fiber length of 5 micrometers to 12 micrometers. In an aspect, the wollastonite fibers can have an average fiber diameter of 10 micrometers to 15 micrometers and an average fiber length of 140 micrometers to 165 micrometers.

In an aspect, the composition comprises the polyetherimide and the filler comprises wollastonite fibers having an average fiber diameter of 5 micrometers to 10 micrometers and an average fiber length of 55 micrometers to 75 micrometers, a surface area of 2.5 m²/g to less than 2.9 m²/g, a bulk density of 0.42 g/cc to 0.50 g/cc, and a silica content of 52% to 55%.

In an aspect, the composition comprises the poly(arylene ether sulfone) and the filler comprises wollastonite fibers having an average fiber diameter of 1 micrometer to 5 micrometers and an average fiber length of 5 micrometers to 12 micrometers, a surface area of 3.8 m²/g to 4.3 m²/g, and a bulk density of 0.48 g/cc to 0.56 g/cc.

In an aspect, the composition comprises the cyclic olefin copolymer and the filler comprises wollastonite fibers having an average fiber diameter of 10 micrometers to 15 micrometers and an average fiber length of 140 micrometers to 165 micrometers, a surface area of 1.0 m²/g to 1.8 m²/g, and a bulk density of 0.18 g/cc to 0.26 g/cc.

In an aspect, the filler can comprise boehmite (also referred to as aluminum oxide hydroxide). The boehmite preferably has a refractive index of 1.60 to 1.68, or 1.60 to 1.67, or 1.60 to 1.66 as determined at a wavelength of 587 nanometers. The inorganic filler can have an average particle size of 0.4 micrometer to less than 0.9 micrometer, as determined by laser light scattering.

In an aspect, the composition comprises the polyetherimide and the filler comprises boehmite having an average particle size (D50), as determined by laser light scattering, of 0.4 micrometer to less than 0.9 micrometer.

In an aspect, the composition comprises the poly(arylene ether sulfone) and the filler comprises boehmite having an average particle size (D50), as determined by laser light scattering, of 0.4 micrometer to less than 0.9 micrometer.

In an aspect, the composition comprises the cyclic olefin copolymer, and the filler does not include boehmite.

The filler can be included in the composition in an amount of greater than 25 weight percent to less than 50 weight percent, based on the total weight of the composition. Within this range, the filler can be present in an amount of 28 weight percent to 48 weight percent, or 30 weight percent to 48 weight percent, or 32 weight percent to 47 weight percent, or 35 weight percent to 45 weight percent, or 38 weight percent to 42 weight percent.

In an aspect, the composition comprises, consists essentially of, or consists of the polyetherimide, the poly(arylene ether sulfone), the cyclic olefin copolymer, or the combination thereof, and the filler. In an aspect, the composition can exclude any component other than the polyetherimide, the poly(arylene ether sulfone), the cyclic olefin polymer, or the combination thereof, and the filler that is not specifically described herein. In an aspect, the composition comprises less than 5 weight percent, or less than 1 weight percent (based on the total weight of the composition) of any thermoplastic polymer other than the polyetherimide, the poly(arylene ether sulfone), and the cyclic olefin copolymer. The composition can optionally exclude any inorganic filler other than the boehmite or wollastonite.

In an aspect, the composition can optionally further comprise an additive composition, comprising one or more additives selected to achieve a desired property, with the proviso that the additive(s) are also selected so as to not significantly adversely affect a desired property of the composition. The additive composition or individual additives can be mixed at a suitable time during the mixing of the components for forming the composition. The additive composition can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination thereof. For example, a combination of a heat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 wt % to 10.0 wt %, or 0.01 wt % to 5 wt %, each based on the total weight of the composition.

In an aspect, the composition can further comprise an additive composition comprising an antioxidant, a thermal stabilizer, a hydrostabilizer, a UV stabilizer, a mold release agent, or a combination comprising at least one of the foregoing.

The composition can be manufactured by various methods generally known in the art. For example, the polyetherimide, poly(arylene ether sulfone), cyclic olefin copolymer, or combination thereof can be blended with the filler, for example in a high-speed mixer or by handmixing. In an aspect, blending the components of the composition can preferably be in the presence of a solvent. Any organic solvent that is capable of solubilizing the components of the composition can be used, for example, ortho-dichlorobenzene, dichloromethane, n-methyl pyrrolidinone, dimethyl or acetamide. The combined components in the solvent can be mixed to disperse the filler for a suitable time (e.g., 1 hour to 10 hours). The methods for manufacturing the composition are further exemplified in the working examples below.

Blending of the components of the composition can be at a temperature of 20° C. to 200° C., preferably 20° C. to 25° C. or 175° C. to 200° C.

In an aspect, the composition can be prepared by contacting an aromatic bis(ether anhydride) and an organic amine to provide a polyetherimide precursor and combining the filler with the polyetherimide precursor to provide a mixture. The mixture can be heated under conditions effective to provide the corresponding polyetherimide (i.e., to facilitate imidization of the precursor).

The composition can be further be formed in a film, for example using various coating techniques that are generally known, including solution coating, spin coating, doctor blading, drop casting, and the like. Solvent can be removed from the films. The thickness of the film can be, for example, 50 micrometers to 500 micrometers, or 50 micrometers to 250 micrometers, or 50 micrometers to 150 micrometers, or 75 micrometers to 125 micrometers.

Films formed from the composition can exhibit one or more advantageous properties. For example, a film formed from the composition can exhibit a flow coefficient of thermal expansion of less than or equal to 36 ppm/° C., or 5 ppm/° C. to 36 ppm/° C., as determined according to ASTM E831. A film formed from the composition can exhibit a percent transmission of greater than 50%, or greater than 50% to 95%, at 1330 nm at a thickness of 100 micrometers. Transmission of the film can be determined by UV/Vis spectroscopy using a Perkin Elmer Lambda 950 spectrometer with an integrating sphere measuring transmittance at a set wavelength of 1330 nanometers. In an aspect, a film formed from the composition can exhibit both of the foregoing properties.

In an aspect, the composition comprises the polyetherimide and the filler comprises the wollastonite, and a film formed from the composition exhibits a flow coefficient of thermal expansion of less than or equal to 25 ppm/° C., or 5 ppm/° C. to 25 ppm/° C., as determined according to ASTM D256; and a percent transmission of greater than 50%, or greater than 50% to 95% at 1330 nanometers, as determined by UV/Vis spectroscopy at a thickness of 100 micrometers.

In an aspect, the composition comprises the polyetherimide and the filler comprises the boehmite, and a film formed from the composition exhibits a flow coefficient of thermal expansion of less than or equal to 35 ppm/° C., or 5 ppm/° C. to 35 ppm/° C., as determined according to ASTM D256; and a percent transmission of greater than 75%, or greater than 75% to 95% at 1330 nanometers, as determined by UV/Vis spectroscopy at a thickness of 100 micrometers.

In an aspect, the composition comprises the poly(arylene ether sulfone) and the filler comprises the wollastonite and a film formed from the composition exhibits a flow coefficient of thermal expansion of less than or equal to 36 ppm/° C., or 5 ppm/° C. to 36 ppm/° C., as determined according to ASTM E831; and a percent transmission of greater than 50%, or greater than 50% to 95%, at 1330 nm as determined by UV/Vis spectroscopy at a thickness of 100 micrometers.

In an aspect, the composition comprises the poly(arylene ether sulfone) and the filler comprises the boehmite and a film formed from the composition exhibits a flow coefficient of thermal expansion of less than or equal to 35 ppm/° C., or 5 ppm/° C. to 35 ppm/° C., as determined according to ASTM E831; and a percent transmission of greater than 50%, or greater than 50% to 95%, at 1330 nm as determined by UV/Vis spectroscopy at a thickness of 100 micrometers.

In an aspect, the composition comprises the cyclic olefin copolymer and the filler comprises the wollastonite and a film formed from the composition exhibits a flow coefficient of thermal expansion of less than or equal to 35 ppm/° C., or 5 ppm/° C. to 35 ppm/° C., as determined according to ASTM E831; and a percent transmission of greater than 50%, or greater than 50% to 95%, at 1330 nm as determined by UV/Vis spectroscopy at a thickness of 100 micrometers.

Articles comprising the composition represent another aspect of the present disclosure. Articles can be prepared, for example, by molding, extruding, or shaping the above-described composition into an article. The composition can be molded into useful shaped articles by a variety of methods, such as injection molding, extrusion, rotational molding, blow molding and thermoforming. Exemplary articles can be in the form of a fiber, a film, a sheet, a pipe, or a molded part. The physical properties of the composition described herein can provide articles that are particularly well-suited for transparent articles, for example for use in optical applications. Such articles can include optical articles, preferably an optic lens, a lens array, transparent materials applications in medical devices, electronic and telecommunications, building and constructions, sensors, antennas, electrodes, thin film optics, thin film substrates, transistors and IR transparent display devices. In an aspect, the article can be a lens for a single mode optical fiber connector.

This disclosure is further illustrated by the following examples, which are non-limiting.

### EXAMPLES

Materials used in the following examples are described in Table 1.

TABLE 1

| Component | Description | Supplier |
|---|---|---|
| PEI | Polyetherimide comprising repeating units derived from 2,2- | SABIC |
| | bis[4-(3,4-dicarboxyphenoxy)phenyl] propane dianhydride | |
| | with metaphenylene diamine, having a weight average | |
| | molecular weight of 45,000 grams per mole, as determined by | |
| | gel permeation chromatography relative to polystyrene | |
| | standards | |
| PPSU | Polyphenylene sulfone, obtained as RADEL R 5100 NT | Solvay |
| PES | Polyether sulfone, obtained as ULTRASON E | BASF Corp |
| PSU | Polysulfone, obtained as UDEL P-1700 | Solvay |
| COC | Cyclic olefin copolymer comprising ethylene-norbornene | TOPAS |
| | copolymer, CAS. Reg. No. 26007-43-2, obtained as TOPAS | |
| | 6017 | |
| Kaolin 1 | Kaolin, obtained as Acti-Min RC15 | Active Minerals |
| Kaolin 2 | Kaolin having a mean particle size of 0.4 micrometers, as | Active Minerals |
| | determined using laser light scattering, obtain as | |
| | KaMin POLYFIL HG90 | |
| Calcium carbonate | Calcium carbonate obtained as Omya 753 | Omya |
| Wollastonite 1 | Wollastonite having a relative particle size of 7 × 63 μm, a | Imerys |
| | surface area of 2.9 m²/g, a bulk density of 0.41 g/cc, and a | |
| | silica content of 51.6%, as determined by X-ray fluorescence | |
| | (XRF), obtained as Nyglos 4W | |
| Wollastonite 2 | Wollastonite having a relative particle size of 12 × 156 μm, a | Imerys |
| | bulk density of 0.22 g/cm³, a BET surface area of 1.4 m²/g | |
| | obtained as Nyglos 8 | |
| Wollastonite 3 | Wollastonite having a relative particle size of 3 × 9 μm, a BET | Imerys |
| | surface area of 4.1 m²/g, and a bulk density of 0.52 g/cm³, | |
| | obtained as M9000 | |
| Wollastonite 4 | Wollastonite with relative particle size 7 × 63 μm, a surface area | Imerys |
| | of 2.7 m²/g, a bulk density of 0.45 g/cc, and a silica content of | |
| | 52.9%, as determined by X-ray fluorescence (XRF) obtained | |
| | as Nyglos M4W | |
| AlO(OH)-1 | Aluminium oxide hydroxide having an average particle size | Anhui Estone |
| | (D50) of 0.1-0.2 μm, obtained as BG-200-Nano | |
| AlO(OH)-2 | Aluminium oxide hydroxide having an average particle size | Nabaltec |
| | (D50) of 0.35 μm, obtained as ACTILOX ® 200 AS1 | |
| | (Boehmite) | |
| AlO(OH)-3 | Aluminium oxide hydroxide having an average particle size | Nabaltec |
| | (D50) of 0.30 μm, obtained as ACTILOX ® 200SM (surface | |
| | modified Boehmite) | |
| AlO(OH)-4 | Aluminium oxide hydroxide having an average particle size | Anhui Estone |
| | (D50) of 0.5 μm, obtained as BG-611 | |
| AlO(OH)-5 | Aluminium oxide hydroxide having an average particle size | Anhui Estone |
| | (D50) of 0.9 μm, obtained as BG-611 | |
| DCM | Dichloromethane | Aldrich |
| oDCB | Ortho-dichlorobenzene | Aldrich |
| NMP | N-Methylpyrrolidone | Aldrich |
| DMAc | Dimethylacetamide | Aldrich |

Compositions were prepared by solution blending polymer and filler, according to the compositions described in Table 2. The amount of each component is provided in weight percent, based on the total weight of the composition. Specifically, the compositions were prepared using one of three methods: 1) dissolving polymer in solvent (PEI withDCM) at room temperature and then adding the filler. The resulting solution was stirred with a mechanical stirrer/shaker to disperse the filler in the resin for 5-7 hours; 2) dissolving polymer in solvent (PEI withoDCB; PPSU with NMP; PES with DMAc; and COC in oDCB) at high temperature and then adding the filler. In this method, into a four necked round bottom flask equipped with a mechanical stirrer, nitrogen inlet, thermowell and Dean-Stark apparatus with reflux condenser, PEI was added with 300 mL dry oDCB. The flask was purged with nitrogen, then heated to 210° C. (oil bath temperature) to remove trace of moisture by the Dean-Stark apparatus. Temperature inside the flask was 180° C. After 90 minutes, PEI was completely dissolved in the oDCB to form a clear solution. Filler was added followed by 50 mL of additional of oDCB. The resulting mixture was allowed to stir at 180° C. for 7-9 hours to complete the dispersion; and 3) into a four necked round bottom flask equipped with a mechanical stirrer, nitrogen inlet, thermowell and Dean-Stark apparatus with reflux condenser, 41 grams of bisphenol-A-dianhydride (BPADA) was added with dry oDCB. The flask was purged with nitrogen, then heated to 210° C. (oil bath temperature) to remove trace of moisture by the Dean-Stark apparatus. Temperature inside the flask was 180° C. After 90 minutes, BPADA was completely dissolved in oDCB to form a clear solution. The reaction mixture was allowed to cool to 90° C. and 8.6 grams of m-phenylene diamine was added to the mixture. The flask was heated to 210° C. (oil bath temperature) while the inside temperature was maintained at 180° C. The reaction mixture was stirred for 90 minutes which resulted in a transparent yellow viscous solution of polyamicacid (PAA). Filler was added followed by 50 mL of additional of oDCB. The fillers were mixed with the polyamic acid to form the filler—PAA mixture. The resulting mixture was stirred at 180° C. for 7-9 hours to complete the polymerization and form the corresponding polyetherimide.

Independent of the process method used, the polymer solution was spread on a glass plate in a longitudinal flow direction using a film applicator blade to control the film thickness. The films were then kept inside the fume hood for 24 hours and peeled off from the glass plate. The films were cut and thermally dried at 120-180° C. under vacuum for 24 hours to remove solvent. The films were cooled to room temperature and tested for thermal and optical properties. The film thickness was 100 micrometers.

Properties were measured using ASTM test methods. All film samples were conditioned for at least 48 hours at 50% relative humidity prior to testing.

The thermal expansion (CTE) measurement was carried out according to ASTM E831 and in the range of 40±100° C. using a DuPont 2940 probe, which provided 0.05 N tension force on the film, at a heating rate of 58° C. per minute. The CTE values on the temperature scale between 30° C. and 80° C. were recorded.

Thermogravimetric analysis (TGA) measurement was carried out in the range of 25° C. to 1000° C. by Q 5000—TA Instruments with the ramp rate 10° C./min in films to measure the filler content, according to ASTM E 1131.

Percent Transmittance measurement was measured in the range of IR region by UV-Vis spectrophotometer Perkin Elmer Lambda 900 spectrometer with integrating spheres and a slit width of 2 nanometers

Haze was measured in the visible region (i.e., 400 nm to 750 nm) with a haze meter (Haze-gard from BYK-Gardner) as per ASTM D1003 standard. Percent haze is calculated from the ratio of diffuse transmittance T_{d}, to total luminous transmittance Tₜ as follows: Haze, %=T_{d}/Tₜ*100).

The compositions of Table 2 were prepared using process 1 as described above. Table 2a

TABLE 2a

| | E1* | E2* | E3* | E4* | E5 | E6* | E7* | E8 | E9* | E10* | E11* | E12* | E13* |
|---|---|---|---|---|---|---|---|---|---|---|---|---|---|
| Component | | | | | | | | | | | | | |
| PEI | 60 | 60 | 60 | 60 | 60 | 60 | 60 | 60 | 60 | 60 | 60 | 60 | 60 |
| PPSU | | | | | | | | | | | | | |
| PES | | | | | | | | | | | | | |
| PSU | | | | | | | | | | | | | |
| COC | | | | | | | | | | | | | |
| Kaolin 1 | | 40 | | | | | | | | | | | |
| Kaolin 2 | | | 40 | | | | | | | | | | |
| Calcium | | | | 40 | | | | | | | | | |
| carbonate | | | | | | | | | | | | | |
| Wollastonite 1 | 40 | | | | | 40 | | | | | | | |
| Wollastonite 2 | | | | | | | 40 | | | | | | |
| Wollastonite 3 | | | | | | | | | 40 | | | | |
| Wollastonite 4 | | | | | | | | 40 | | | | | |
| AlO(OH)-1 | | | | | | | | | | 40 | | | |
| AlO(OH)-2 | | | | | | | | | | | | 40 | |
| AlO(OH)-3 | | | | | | | | | | | 40 | | |
| AlO(OH)-4 | | | | | 40 | | | | | | | | |
| AlO(OH)-5 | | | | | | | | | | | | | 40 |
| Properties | | | | | | | | | | | | | |
| CTE (ppm/° C.) | 22 | 41 | 52 | 44 | 35 | 22 | 21 | 21 | 45.6 | 41 | 46 | 48.2 | 40 |
| % Transmittance | 43 | 8 | 14 | 20 | 74 | 43 | 4 | 54 | 48 | 77 | 75 | 72 | 60 |
| @ 1330 nm | | | | | | | | | | | | | |
| % Filler by TGA | 38 | 39 | 40 | 39 | 38 | 38 | 40 | 39 | 39 | 39 | 40 | 39 | 40 |

*indicates a comparative example

TABLE 2b

| | E14* | E15* | E16* | E17* | E18* | E19* | E20* | E21* | E22* | E23* | E24* | E25* |
|---|---|---|---|---|---|---|---|---|---|---|---|---|
| Component | | | | | | | | | | | | |
| PEI | 90 | 80 | 70 | 50 | 90 | 80 | 70 | 50 | 90 | 80 | 70 | 50 |
| PPSU | | | | | | | | | | | | |
| PES | | | | | | | | | | | | |
| PSU | | | | | | | | | | | | |
| COC | | | | | | | | | | | | |
| Kaolin 1 | | | | | | | | | | | | |
| Kaolin 2 | | | | | | | | | | | | |
| Calcium | | | | | | | | | | | | |
| carbonate | | | | | | | | | | | | |
| Wollastonite 1 | | | | | | | | | | | | |
| Wollastonite 2 | | | | | | | | | 10 | 20 | 30 | 50 |
| Wollastonite 3 | 10 | 20 | 30 | 50 | | | | | | | | |
| Wollastonite 4 | | | | | | | | | | | | |
| AlO(OH)-1 | | | | | 10 | 20 | 30 | 50 | | | | |
| AlO(OH)-2 | | | | | | | | | | | | |
| AlO(OH)-3 | | | | | | | | | | | | |
| AlO(OH)-4 | | | | | | | | | | | | |
| AlO(OH)-5 | | | | | | | | | | | | |
| Properties | | | | | | | | | | | | |
| CTE (ppm/° C.) | 65 | 49 | 48 | 30 | 49 | 48 | 48 | 35 | 58 | 35 | 25 | 13 |
| % Transmittance | 72 | 64 | 49 | 27 | 87 | 85 | 81 | 60 | 28 | 14 | 8 | 1 |
| @ 1330 nm | | | | | | | | | | | | |
| % Filler by TGA | 9 | 19 | 29 | 50 | 10 | 19 | 30 | 50 | 10 | 19 | 29 | 49 |

*indicates a comparative example

TABLE 2c

| | E26* | E27* | E28* | E29* | E30* | E31* | E32* | E33* | E34* | E35* | E36* | E37* |
|---|---|---|---|---|---|---|---|---|---|---|---|---|
| Component | | | | | | | | | | | | |
| PEI | 90 | 80 | 70 | 50 | 90 | 80 | 70 | 50 | 90 | 80 | 70 | 50 |
| PPSU | | | | | | | | | | | | |
| PES | | | | | | | | | | | | |
| PSU | | | | | | | | | | | | |
| COC | | | | | | | | | | | | |
| Kaolin 1 | | | | | | | | | | | | |
| Kaolin 2 | | | | | | | | | | | | |
| Calcium | | | | | | | | | | | | |
| carbonate | | | | | | | | | | | | |
| Wollastonite 1 | | | | | | | | | | | | |
| Wollastonite 2 | | | | | | | | | | | | |
| Wollastonite 3 | | | | | | | | | | | | |
| Wollastonite 4 | 10 | 20 | 30 | 50 | | | | | | | | |
| AlO(OH)-1 | | | | | | | | | | | | |
| AlO(OH)-2 | | | | | 10 | 20 | 30 | 50 | | | | |
| AlO(OH)-3 | | | | | | | | | 10 | 20 | 30 | 50 |
| AlO(OH)-4 | | | | | | | | | | | | |
| AlO(OH)-5 | | | | | | | | | | | | |
| Properties | | | | | | | | | | | | |
| CTE (ppm/° C.) | 58 | 49 | 28 | 11 | 57 | 50 | 47 | 41 | 61 | 56 | 46 | 30 |
| % Transmittance | 65 | 60 | 57 | 24 | 76 | 77 | 78 | 64 | 68 | 60 | 58 | 40 |
| @ 1330 nm | | | | | | | | | | | | |
| % Filler by TGA | 9 | 19 | 30 | 49 | 10 | 19 | 30 | 49 | 9 | 19 | 30 | 50 |

*indicates a comparative example

TABLE 2d

| Component | E38* | E39* | E40* | E41* |
|---|---|---|---|---|
| PEI | 90 | 80 | 70 | 50 |
| PPSU | | | | |
| PES | | | | |
| PSU | | | | |
| COC | | | | |
| Kaolin 1 | | | | |
| Kaolin 2 | | | | |
| Calcium carbonate | | | | |
| Wollastonite 1 | | | | |
| Wollastonite 2 | | | | |
| Wollastonite 3 | | | | |
| Wollastonite 4 | | | | |
| AlO(OH)-1 | | | | |
| AlO(OH)-2 | | | | |
| AlO(OH)-3 | | | | |
| AlO(OH)-4 | 10 | 20 | 30 | 50 |
| AlO(OH)-5 | | | | |
| Properties | | | | |
| CTE (ppm/° C.) | 52 | 48 | 42 | 40 |
| % Transmittance @ 1330 nm | 86 | 84 | 80 | 70 |
| % Filler by TGA | 10 | 20 | 29 | 50 |

The compositions of Table 3 were prepared using process 2 as described above.

TABLE 3a

| | E42 * | E43 * | E44 | E45 | E46 * | E47 * | E48 * | E49 * | E50 * | E51 * | E52 * | E53 |
|---|---|---|---|---|---|---|---|---|---|---|---|---|
| Component | | | | | | | | | | | | |
| PEI | | | | | | | | | | | | |
| PPSU | 70 | 60 | 70 | 60 | 60 | | | | | | | |
| PES | | | | | | 60 | 60 | 60 | 60 | | | |
| PSU | | | | | | | | | | 60 | 60 | 60 |
| COC | | | | | | | | | | | | |
| Kaolin 1 | | | | | | | | | | | | |
| Kaolin 2 | | | | | | | | | | | | |
| Calcium | | | | | | | | | | | | |
| carbonate | | | | | | | | | | | | |
| Wollastonite 1 | | | | | | | | 40 | | | | |
| Wollastonite 2 | | | | | | | | | | | | |
| Wollastonite 3 | | | | | | | | | 40 | | | 40 |
| Wollastonite 4 | 30 | 40 | | | | | 40 | | | 40 | | |
| AlO(OH)-1 | | | | | 40 | | | | | | 40 | |
| AlO(OH)-2 | | | | | | | | | | | | |
| AlO(OH)-3 | | | | | | | | | | | | |
| AlO(OH)-4 | | | 30 | 40 | | | | | | | | |
| AlO(OH)-5 | | | | | | 40 | | | | | | |
| Properties | | | | | | | | | | | | |
| CTE (ppm/° C.) | 30 | 22 | 34 | 30 | 35 | 50 | 25 | 32 | 33 | 17 | 23 | 36 |
| % Transmittance | 52 | 44 | 84 | 79 | 74 | 4 | 4 | 4 | 5 | 15 | 20 | 70 |
| @ 1330 nm | | | | | | | | | | | | |
| % Transmittance | 86 | 78 | 89 | 88 | 88 | | | | | 66 | 70 | 86 |
| in visible region | | | | | | | | | | | | |
| % Haze in | 78 | 78 | 32 | 29 | 40 | 100 | 100 | 100 | 100 | 100 | 90 | 74 |
| visible region | | | | | | | | | | | | |
| % Filler by TGA | | | | | | | | | | | | |

TABLE 3b

| | E54* | E55* | E56* | E57 | E58* | E59* | E60* |
|---|---|---|---|---|---|---|---|
| Component | | | | | | | |
| PEI | | | | | | | |
| PPSU | | | | | | | |
| PES | | | | | | | |
| PSU | 60 | 60 | | | | | |
| COC | | | 60 | 60 | 60 | 60 | 60 |
| Kaolin 1 | 40 | | | | | | 40 |
| Kaolin 2 | | | | | | | |
| Calcium carbonate | | | | | | | |
| Wollastonite 1 | | | | | | 40 | |
| Wollastonite 2 | | | | | | | |
| Wollastonite 3 | | | | | | | |
| Wollastonite 4 | | | 40 | | | | |
| AlO(OH)-1 | | | | | 40 | | |
| AlO(OH)-2 | | | | | | | |
| AlO(OH)-3 | | | | | | | |
| AlO(OH)-4 | | 40 | | 40 | | | |
| AlO(OH)-5 | | | | | | | |
| Properties | | | | | | | |
| CTE (ppm/° C.) | 48 | 28 | 21 | 24 | 34 | 20 | 45 |
| % Transmittance @ | 15 | 33 | 45 | 61 | 43 | 30 | 35 |
| 1330 nm | | | | | | | |
| % Transmittance in | 72 | 65 | 84 | 88 | 71 | 77 | 52 |
| visible region | | | | | | | |
| % Haze in visible | 84 | 79 | 70 | 68 | 80 | 85 | 60 |
| region (400-750 nm) | | | | | | | |
| % Filler by TGA | | | | | | | |

*indicates a comparative example

Examples 1-5 demonstrate the effect of different types of fillers in PEI compositions. Compositions of each of these examples were prepared according to method (1) described above. Example 1 shows that by using wollastonite 1 in a particular amount provides a composition capable of achieving a combination of percent transmittance at 1330 nm of greater than or equal to 50, and a CTE of less than 25 ppm/° C. Example 5 shows that using a boehmite filler in a particular amount provides a composition capable of achieving a composition of percent transmittance at 1330 nm of greater than or equal to 75 and a CTE of less than 35 ppm/° C.

Examples 6-9 demonstrate that the particle size of the filler can affect the resulting PEI composition. Compositions of each of these examples were prepared according to method (1) described above. In particular, these examples demonstrate that by using certain wollastonite filler in a particular amount yields a composition capable of achieving a combination of percent transmittance at 1330 nm greater than or equal to 50 and CTE lesser than 25 ppm/° C. It was expected that lower particle size of wollastonite fillers would enhance the CTE and % T performance due to the dilution effect and same mineral composition. However, only the composition including wollastonite 4 showed the improvement in the % T at 1330 nm performance in comparison with the other wollastonite fillers.

Similarly, examples 10-13 demonstrate that by using certain boehmite filler in a particular amount yields a composition capable of achieving a combination of percent transmittance at 1330 nm greater than or equal to 75 and CTE lesser than 35 ppm/° C. It was expected that lower particle size of boehmite fillers would enhance the CTE and % T performance due to the dilution effect and same mineral composition. However, only the composition including AlO(OH)-4 showed the improvement in the % T at 1330 nm performance in comparison with the other boehmite fillers.

Examples 14-17 and 22-29 show that a particular amount and a particular size distribution of wollastonite is required in order to achieve the desired combination of percent transmittance of greater than or equal to 50% at 1330 nm and a CTE of less than 25 ppm/° C.

Examples 18-21 and 30-41 show that a particular amount of boehmite is required in order to achieve the desired combination of percent transmittance of greater than or equal to 75% at 1330 nm and a CTE of less than 35 ppm/° C.

The results shown in Table 2 were unexpected since each filler has a refractive index close to that of the PEI, however, as indicated by the CTE and % T shown in Table 2, each filler did not provide the same effect on the properties of the resulting composition. Additionally, fillers such as kaolin and calcium carbonate also did not show the desired CTE and % T compared to wollastonite or boehmite. The examples shown in Table 2 clearly show that the desired CTE and % T were obtained only when a particular combination of PEI and wollastonite or boehmite was used, and further when the filler possessed a particular particle size. When either lower or higher particle sizes were used, the same improvement in CTE and % T was not observed.

The data shown in Tables 2 and 3 illustrate that there are several factors affecting the selection of a combination of a polymer and a filler. More specifically, different types of fillers can provide different results depending on the selection of a polyetherimide, a poly(arylene ether sulfone), or a cyclic olefin copolymer. Without wishing to be bound by theory, each of these polymers possess different chemical compositions and structures, which can lead to different zeta potentials, hydrophilic/hydrophobic balance, and end group interactions, each of which can have an effect of the stability of the resulting composition. Thus, without wishing to be bound by theory, it is believed that polymer/filler interaction energy, polymer swelling behavior, chain entanglement density, surface energy, degree of solvation of the polymer, and polymer viscosity in the presence of the filler can each have an effect on the properties (in particular, optical properties such as haze and transmission and thermal properties such as coefficient of thermal expansion) of the composition.

The following examples demonstrate the effect of the method of making the composition. Compositions were prepared according to the process indicated in Table 4.

TABLE 4

| | E61 | E62 | E63* | E64 | E65 | E66* | E67* | E68 | E69 | E70* | E71* |
|---|---|---|---|---|---|---|---|---|---|---|---|
| Component | | | | | | | | | | | |
| Process | 2 | 2 | 2 | 2 | 3 | 2 | 3 | 2 | 3 | 2 | 3 |
| PEI-1 | 60 | 60 | 60 | 60 | 60 | 60 | 60 | 60 | 60 | 60 | 60 |
| Kaolin 1 | | | | | | | | | | | |
| Kaolin 2 | | | | | | | | | | | |
| Calcium | | | | | | | | | | | |
| carbonate | | | | | | | | | | | |
| Wollastonite 1 | | 40 | | | | | | | | | |
| Wollastonite 2 | | | | | | | | | | | |
| Wollastonite 3 | | | 40 | | | 40 | 40 | | | | |
| Wollastonite 4 | 40 | | | 40 | 40 | | | | | | |
| AlO(OH)-1 | | | | | | | | | | | |
| AlO(OH)-2 | | | | | | | | | | | |
| AlO(OH)-3 | | | | | | | | | | | |
| AlO(OH)-4 | | | | | | | | 40 | 40 | | |
| AlO(OH)-5 | | | | | | | | | | 40 | 40 |
| Properties | | | | | | | | | | | |
| CTE (ppm/° C.) | 21 | 24 | 36 | 21 | 22 | 36 | 31 | 33 | 31 | 38 | 37 |
| % Transmittance | 61 | 59 | 55 | 61 | 73 | 55 | 56 | 73 | 80 | 66 | 70 |
| % Filler by TGA | 39 | 40 | 38 | 39 | 40 | 38 | 39 | 40 | 40 | 40 | 40 |

*indicates a comparative example

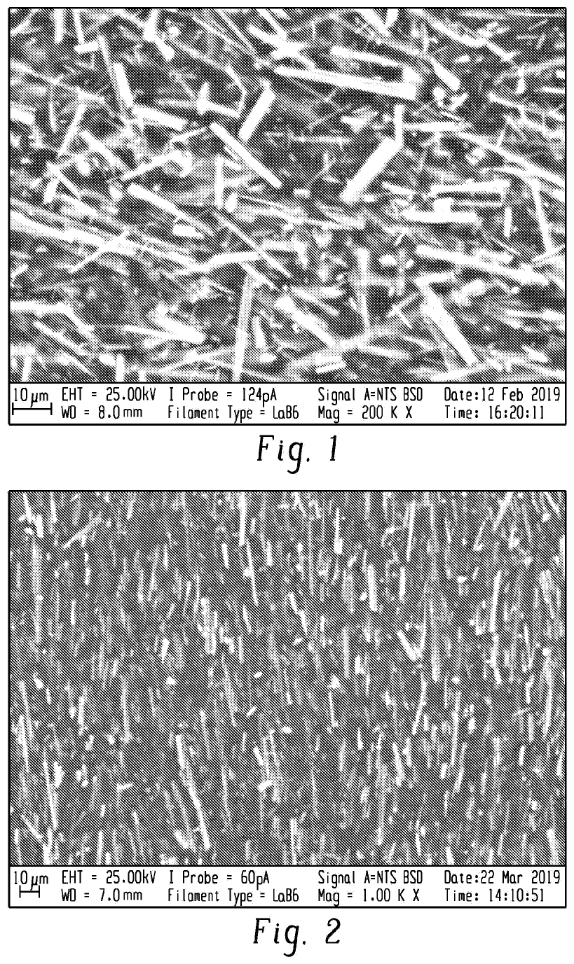

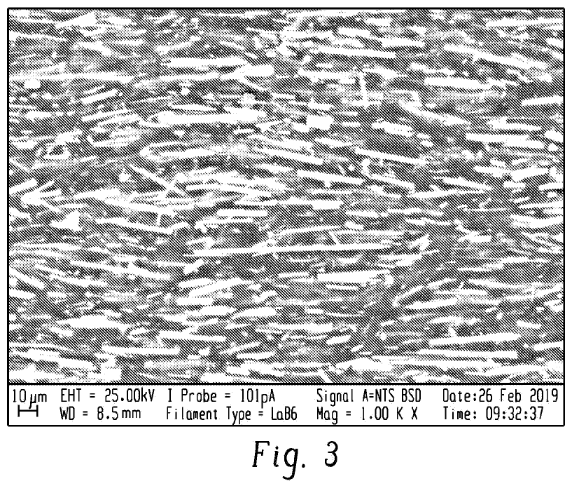

A comparison of examples 61-67 and those made by process 1 with similar compositions in Table 2 show that certain compositions with a particular particle size and process method yield the desired properties with respect to CTE and % T. Use of process 2 or 3 was also observed to provide enhanced dispersion and distribution of the filler in the composition compared to process 1. This can be observed by scanning electron microscopy for example as shown in FIG. 1 (SEM of example 8), FIG. 2 (SEM of example 61), and FIG. 3 (SEM of example 65). Similar results were obtained when using the boehmite filler, as shown in examples 68-71 of Table 4.

This disclosure further encompasses the following aspects.

Aspect 1: A composition comprising greater than 50 weight percent to less than 75 weight percent of a polyetherimide, a poly(arylene ether sulfone), or a cyclic olefin copolymer; and greater than 25 weight percent to less than 50 weight percent of a filler; wherein when the polymer comprises the polyetherimide, the filler comprises wollastonite fibers having an average fiber diameter of 5 micrometers to 10 micrometers and an average fiber length of 55 micrometers to 75 micrometers, a surface area of 2.5 m²/g to less than 2.9 m²/g, a bulk density of 0.42 g/cc to 0.50 g/cc, and a silica content of 52% to 55%; or boehmite having an average particle size (D50), as determined by laser light scattering, of 0.4 micrometer to less than 0.9 micrometer; when the polymer comprises the poly(arylene ether sulfone), the filler comprises wollastonite fibers having an average fiber diameter of 1 micrometers to 5 micrometers and an average fiber length of 5 micrometers to 12 micrometers, a surface area of 3.8 m²/g to 4.3 m²/g, and a bulk density of 0.48 g/cc to 0.56 g/cc; or boehmite having an average particle size (D50), as determined by laser light scattering, of 0.4 micrometer to less than 0.9 micrometer; and when the polymer comprises the cyclic olefin copolymer, the filler comprises wollastonite fibers having an average fiber diameter of 10 micrometers to 15 micrometers and an average fiber length of 140 micrometers to 165 micrometers, a surface area of 1.0 m²/g to 1.8 m²/g, and a bulk density of 0.18 g/cc to 0.26 g/cc; wherein weight percent is based on the total weight of the composition.

Aspect 2: The composition of aspect 1, a flow coefficient of thermal expansion of less than or equal to 36 ppm/° C., or 5 ppm/° C. to 36 ppm/° C., as determined according to ASTM E831; and a percent transmission of greater than 50%, or greater than 50% to 95%, at 1330 nm as determined by UV/Vis spectroscopy at a thickness of 100 micrometers.

Aspect 3: The composition of aspect 1 or 2, comprising 53 weight percent to 68 weight percent, or 55 weight percent to 65 weight percent, or 58 weight percent to 62 weight percent of the polyetherimide, the poly(arylene ether sulfone), the cyclic olefin copolymer, or combination thereof; and 32 weight percent to 47 weight percent, or 35 weight percent to 45 weight percent, or 38 weight percent to 42 weight percent of the filler.

Aspect 4: The composition of any of aspects 1 to 3, wherein the polyetherimide is present and the filler comprises the wollastonite, wherein a film formed from the composition exhibits a flow coefficient of thermal expansion of less than or equal to 25 ppm/° C., or 5 ppm/° C. to 25 ppm/° C., as determined according to ASTM D256; and a percent transmission of greater than 50%, or greater than 50% to 95% at 1330 nanometers, as determined by UV/Vis spectroscopy at a thickness of 100 micrometers.

Aspect 5: The composition of any of aspects 1 to 3, wherein the polyetherimide is present and the filler comprises the boehmite, wherein a film formed from the composition exhibits a flow coefficient of thermal expansion of less than or equal to 35 ppm/° C., or 5 ppm/° C. to 35 ppm/° C., as determined according to ASTM D256; and a percent transmission of greater than 75%, or greater than 75% to 95% at 1330 nanometers, as determined by UV/Vis spectroscopy at a thickness of 100 micrometers.

Aspect 6: The composition of any of aspects 1 to 3, wherein the poly(arylene ether sulfone) is present and the filler comprises the wollastonite, wherein a film formed from the composition exhibits a flow coefficient of thermal expansion of less than or equal to 36 ppm/° C., or 5 ppm/° C. to 36 ppm/° C., as determined according to ASTM E831; and a percent transmission of greater than 50%, or greater than 50% to 95%, at 1330 nm as determined by UV/Vis spectroscopy at a thickness of 100 micrometers.

Aspect 7: The composition of any of aspects 1 to 3, wherein the poly(arylene ether sulfone) is present and the filler comprises the boehmite, wherein a film formed from the composition exhibits a flow coefficient of thermal expansion of less than or equal to 35 ppm/° C., or 5 ppm/° C. to 35 ppm/° C., as determined according to ASTM E831; and a percent transmission of greater than 50%, or greater than 50% to 95%, at 1330 nm as determined by UV/Vis spectroscopy at a thickness of 100 micrometers.

Aspect 8: The composition of any of aspects 1 to 3, wherein the cyclic olefin copolymer is present and the filler comprises the wollastonite, wherein a film formed from the composition exhibits a flow coefficient of thermal expansion of less than or equal to 35 ppm/° C., or 5 ppm/° C. to 35 ppm/° C., as determined according to ASTM E831; and a percent transmission of greater than 50%, or greater than 50% to 95%, at 1330 nm as determined by UV/Vis spectroscopy at a thickness of 100 micrometers.

Aspect 9: A method of making the composition of any of aspects 1 to 8, the method comprising: blending the polyetherimide, the poly(arylene ether sulfone), or the cyclic olefin copolymer and the filler.

Aspect 10: The method of aspect 9, wherein blending the polyetherimide, the poly(arylene ether sulfone), or the cyclic olefin copolymer and the filler is in the presence of a solvent.

Aspect 11: The method of aspect 9 or 10, wherein blending the polyetherimide, the poly(arylene ether sulfone), or the cyclic olefin copolymer is at a temperature of 20 to 200° C., preferably 20 to 25° C. or 175 to 200° C.

Aspect 12: A method of making the composition of any of aspects 1 to 8, wherein the composition comprises the polyetherimide and the method comprises: contacting an aromatic bis(ether anhydride) and an organic amine to provide a polyetherimide precursor; combining the filler with the polyetherimide precursor to provide a mixture; and heating the mixture under conditions effective to provide the corresponding polyetherimide.

Aspect 13: An article comprising the composition of any of aspects 1 to 8.

Aspect 14: The article of aspect 13, wherein the article is an optical article, preferably an optic lens, a lens array, transparent materials applications in medical devices, electronic and telecommunications, building and constructions, sensors, antennas, electrodes, thin film optics, thin film substrates, transistors and IR transparent display devices.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising
greater than 50 weight percent to less than 75 weight percent of a polyetherimide, a poly(arylene ether sulfone), or a cyclic olefin copolymer; and
greater than 25 weight percent to less than 50 weight percent of a filler;
wherein
when the polymer comprises the polyetherimide, the filler comprises
wollastonite fibers having an average fiber diameter of 5 micrometers to 10 micrometers and an average fiber length of 55 micrometers to 75 micrometers, a surface area of 2.5 m²/g to less than 2.9 m²/g, a bulk density of 0.42 g/cc to 0.50 g/cc, and a silica content of 52% to 55%; or
boehmite having an average particle size (D50), as determined by laser light scattering, of 0.4 micrometer to less than 0.9 micrometer;
when the polymer comprises the poly(arylene ether sulfone), the filler comprises
wollastonite fibers having an average fiber diameter of 1 micrometers to 5 micrometers and an average fiber length of 5 micrometers to 12 micrometers, a surface area of 3.8 m²/g to 4.3 m²/g, and a bulk density of 0.48 g/cc to 0.56 g/cc; or
boehmite having an average particle size (D50), as determined by laser light scattering, of 0.4 micrometer to less than 0.9 micrometer; and
when the polymer comprises the cyclic olefin copolymer, the filler comprises
wollastonite fibers having an average fiber diameter of 10 micrometers to 15 micrometers and an average fiber length of 140 micrometers to 165 micrometers, a surface area of 1.0 m²/g to 1.8 m²/g, and a bulk density of 0.18 g/cc to 0.26 g/cc;
wherein weight percent is based on the total weight of the composition.

2. The composition of claim 1, wherein a film formed from the composition exhibits
a flow coefficient of thermal expansion of less than or equal to 36 ppm/° C., or 5 ppm/° C. to 36 ppm/° C., as determined according to ASTM E831; and
a percent transmission of greater than 50%, or greater than 50% to 95%, at 1330 nm as determined by UV/Vis spectroscopy at a thickness of 100 micrometers.

3. The composition of claim 1, comprising
53 weight percent to 68 weight percent, or 55 weight percent to 65 weight percent, or 58 weight percent to 62 weight percent of the polyetherimide, the poly(arylene ether sulfone), the cyclic olefin copolymer, or combination thereof; and
32 weight percent to 47 weight percent, or 35 weight percent to 45 weight percent, or 38 weight percent to 42 weight percent of the filler.

4. The composition of claim 1, wherein the polyetherimide is present and the filler comprises the wollastonite, wherein a film formed from the composition exhibits
a flow coefficient of thermal expansion of less than or equal to 25 ppm/° C., or 5 ppm/° C. to 25 ppm/° C., as determined according to ASTM D256; and
a percent transmission of greater than 50%, or greater than 50% to 95% at 1330 nanometers, as determined by UV/Vis spectroscopy at a thickness of 100 micrometers.

5. The composition of claim 1, wherein the polyetherimide is present and the filler comprises the boehmite, wherein a film formed from the composition exhibits
a flow coefficient of thermal expansion of less than or equal to 35 ppm/° C., or 5 ppm/° C. to 35 ppm/° C., as determined according to ASTM D256; and
a percent transmission of greater than 75%, or greater than 75% to 95% at 1330 nanometers, as determined by UV/Vis spectroscopy at a thickness of 100 micrometers.

6. The composition of claim 1, wherein the poly(arylene ether sulfone) is present and the filler comprises the wollastonite, wherein a film formed from the composition exhibits
a flow coefficient of thermal expansion of less than or equal to 36 ppm/° C., or 5 ppm/° C. to 36 ppm/° C., as determined according to ASTM E831; and
a percent transmission of greater than 50%, or greater than 50% to 95%, at 1330 nm as determined by UV/Vis spectroscopy at a thickness of 100 micrometers.

7. The composition of claim 1, wherein the poly(arylene ether sulfone) is present and the filler comprises the boehmite, wherein a film formed from the composition exhibits
a flow coefficient of thermal expansion of less than or equal to 35 ppm/° C., or 5 ppm/° C. to 35 ppm/° C., as determined according to ASTM E831; and
a percent transmission of greater than 50%, or greater than 50% to 95%, at 1330 nm as determined by UV/Vis spectroscopy at a thickness of 100 micrometers.

8. The composition of claim 1, wherein the cyclic olefin copolymer is present and the filler comprises the wollastonite, wherein a film formed from the composition exhibits
a flow coefficient of thermal expansion of less than or equal to 35 ppm/° C., or 5 ppm/° C. to 35 ppm/° C., as determined according to ASTM E831; and
a percent transmission of greater than 50%, or greater than 50% to 95%, at 1330 nm as determined by UV/Vis spectroscopy at a thickness of 100 micrometers.

9. A method of making the composition of claim 1, the method comprising:
blending the polyetherimide, the poly(arylene ether sulfone), or the cyclic olefin copolymer and the filler.

10. The method of claim 9, wherein blending the polyetherimide, the poly(arylene ether sulfone), or the cyclic olefin copolymer and the filler is in the presence of a solvent.

11. The method of claim 9, wherein blending the polyetherimide, the poly(arylene ether sulfone), or the cyclic olefin copolymer is at a temperature of 20 to 200° C., preferably 20 to 25° C. or 175 to 200° C.

12. A method of making the composition of claim 1, wherein the composition comprises the polyetherimide and the method comprises:
contacting an aromatic bis(ether anhydride) and an organic amine to provide a polyetherimide precursor;
combining the filler with the polyetherimide precursor to provide a mixture; and
heating the mixture under conditions effective to provide the corresponding polyetherimide.

13. An article comprising the composition of claim 1.

14. The article of claim 13, wherein the article is an optical article, preferably an optic lens, a lens array, transparent materials applications in medical devices, electronic and telecommunications, building and constructions, sensors, antennas, electrodes, thin film optics, thin film substrates, transistors and IR transparent display devices.
